(19) United States
(12) Patent Application Publication
(10) Pub. No.: US 2025/0089975 A1
(43) Pub. Date: Mar. 20, 2025

(54) Method for operating a system and system comprising a floor cleaning machine and a supply device

(71) Applicant: Hako GmbH, Bad Oldesloe (DE)

(72) Inventors: Axel ZIMNY, Großhandsdorf (DE); Björn BRANDT, Hamburg (DE); Arne REIMERS, Stein (DE); Christian WULF, Berkenthin (DE)

(21) Appl. No.: 18/889,612

(22) Filed: Sep. 19, 2024

(30) Foreign Application Priority Data
Sep. 19, 2023 (DE) DE102023125323.9

(51) Int. Cl. A47L 11/40; A47L 11/30; G05D 1/661; G05D 105/10

(52) U.S. Cl. CPC A47L 11/4091; A47L 11/30; A47L 11/4005; A47L 11/4011; A47L 11/4019; A47L 11/4025; A47L 11/4061; A47L 11/4066; A47L 11/4072; A47L 11/4083; G05D 1/661; A47L 2201/022; A47L 2201/024; A47L 2201/026; G05D 2105/10

(57) ABSTRACT

A method for operating a system comprising a floor cleaning machine and a supply device, including actuating the supply device so that the supply device assumes the second position, moving the floor cleaning machine in the opposite direction to the first direction of travel so that the floor cleaning machine moves towards the supply device in such a manner that during the movement the first coupling arrangement points towards the second coupling arrangement, conveying fresh water from the fresh water inlet into the fresh water tank and/or conveying waste water from the waste water tank to the waste water outlet and/or charging the battery with the power supply, releasing the connection between the first and the second coupling arrangement by moving the supply device in the opposite direction to the first direction of travel from the second position to the first position.

### TECHNICAL FIELD

The present disclosure relates to a method for operating a system and a system comprising a floor cleaning machine and a supply device.

### BACKGROUND

Systems consisting of a floor cleaning machine and a supply device are known from the prior art. The floor cleaning machines known from the prior art, wherein these can be, for example, autonomously operating cleaning robots, hand-operated floor cleaning machines and ride-on machines, usually have a chassis with at least one wheel, which may be driven by a drive unit, a cleaning device, for example in the form of a brush arrangement, a wiping device and/or a suction device, a fresh water tank for holding fresh water, a waste water tank for holding waste water and a coupling arrangement for coupling the floor cleaning machine to the supply device. Generally speaking, known supply devices also have a coupling arrangement for coupling the supply device to the floor cleaning machine, a power supply, a fresh water supply and a waste water intake.

Also known are methods for operating a system comprising such a floor cleaning machine and such a supply device. In the known methods, the floor cleaning machine is generally positioned in front of the supply device and then moved towards it in order to couple the floor cleaning machine to the supply device via the coupling arrangements, and moved away from it in order to decouple the floor cleaning machine from the supply device.

With such floor cleaning machines, supply devices and methods for operating them, it has proven to be problematic that the floor cleaning machine is moved towards the supply devices for coupling and that the supply devices remain stationary in the process. With the known methods, it is necessary for the floor cleaning machine to move up to the supply device until the coupling units contact for coupling purposes and, beyond that, to press against the supply device so that the coupling units form a secure connection. Such coupling processes can cause additional loads on the supply device, which can result in damage to the supply device or the floor cleaning machine and its coupling arrangements. In addition, the supply device can be tilted or displaced during the coupling process, which can also lead to issues.

Another disadvantage is that the floor cleaning machines have to drive in reverse in order to release the coupling of the coupling units. On the one hand, this results in a higher space requirement for decoupling. If the floor cleaning machine is an autonomous cleaning robot, it must also possess additional sensors that can check the rear region for obstacles prior to and during reversing.

### SUMMARY

A method for operating a system comprising a floor cleaning machine and a supply device, which can be coupled and released in a particularly simple and safe manner without requiring additional space and without the floor cleaning machine performing a reversing movement for release.

According to a first aspect, the object is achieved by a method having the features of claim 1. The method is directed to the operation of a system comprising a floor cleaning machine, which can be, for example, an autonomously operating cleaning robot, a hand-operated floor cleaning machine or a ride-on machine, and a supply device. The floor cleaning machine has a chassis with at least one wheel that is possibly driven by a chassis drive, wherein the chassis is designed in such a way that the floor cleaning machine can be moved over a floor surface. The floor cleaning machine has at least one cleaning device that is designed to engage with the floor surface. Furthermore, the floor cleaning machine has a fresh water tank for holding fresh water, a waste water tank for holding waste water and/or a rechargeable battery for supplying power to the floor cleaning machine and a first coupling arrangement. The fresh water tank, the waste water tank and/or the battery are connected to the first coupling arrangement. The supply device can be moved by means of a drive unit connected to it on the floor surface in or in the opposite direction to a possibly straight first direction of travel between a first and a second position, wherein the supply device is moved from the first to the second position by a movement in the first direction of travel. The supply device has a second coupling arrangement that can be connected to the first coupling arrangement, wherein the first direction of travel points in the direction in which the second coupling arrangement must be moved in order to be connected to the first coupling arrangement. The second coupling arrangement is connected to a fresh water inlet, a waste water outlet and/or to a power supply. The supply device and the floor cleaning machine are designed in such a way that, when the first and second coupling arrangements are connected to one another, fresh water can be conveyed from the fresh water inlet into the fresh water tank and/or waste water can be conveyed from the waste water tank to the waste water outlet and/or the battery is connected to the power supply. Alternatively or in addition, it is conceivable that other liquids, for example a cleaning agent, can also be conveyed via the coupling arrangements.

An embodiment of the method comprises the following steps. Actuating the supply device so that the supply device assumes the second position. Moving the floor cleaning machine in the opposite direction to the first direction of travel, possibly by means of the chassis drive, so that the floor cleaning machine moves towards the supply station in such a manner that during the movement the first coupling arrangement points towards the second coupling arrangement. Coupling the floor cleaning machine and the supply device by connecting the first coupling arrangement to the second coupling arrangement. Conveying fresh water from the fresh water inlet into the fresh water tank and/or conveying waste water from the waste water tank to the waste water outlet and/or charging the battery with the power supply. Releasing the connection between the first and the second coupling arrangement by moving the supply device in the opposite direction to the first direction of travel from the second position to the first position.

As already mentioned, the floor cleaning machine may have at least one cleaning device that is designed to engage with the floor surface. The cleaning device can have a brush arrangement, a wiping device, a device for dispensing fresh water, optionally mixed with cleaning agents, and/or a suction pad, with which waste water can be absorbed from the floor surface. The brush arrangement and the wiping device are possibly driven and engage with the floor surface in such a way that they loosen and/or remove dirt from the floor surface. The suction pad can be used to suck up dirt together with previously dispensed fresh water and guide it into the waste water tank. This has the advantage that floor surfaces with particularly heavy contamination can be cleaned in a very simple way.

Furthermore, the floor cleaning machine may have a fresh water tank for holding fresh water, a waste water tank for holding waste water and/or a rechargeable battery for supplying power to the floor cleaning machine and a first coupling arrangement. The fresh water tank and the waste water tank are connected to the cleaning device so that the fresh water can be transferred from the fresh water tank to the floor surface and the waste water from the floor surface to the waste water tank. It is also possible in this regard for the floor cleaning machine to alternatively or additionally have a cleaning solution tank for a cleaning solution that is mixed with the fresh water or applied separately to the floor surface to be cleaned. The cleaning device can have a fresh water supply device and a suction device. The rechargeable battery is used to supply the floor cleaning machine with electrical energy so that the floor cleaning machine can operate wirelessly.

The fresh water tank, the waste water tank and/or the battery and possibly also the cleaning solution tank may be connected to the first coupling arrangement. The coupling arrangement can be used to fill the fresh water tank with fresh water, empty the waste water from the waste water tank and/or charge the battery of the floor cleaning machine. The first coupling arrangement forms an interface for connection to a supply device. This has the advantage that the floor cleaning machine can be connected to a supply device via the coupling arrangement. The first coupling arrangement possibly has a plug and a waste water valve, wherein the plug has an interface for supplying fresh water and an interface for supplying electrical energy, with which the battery of the floor cleaning machine can be charged. Further possibly, the plug of the first coupling arrangement can have an interface for sending and receiving data, which is connected to a control unit of the floor cleaning machine via a data bus. This has the advantage that the floor cleaning machine can exchange data with the supply device or an external control unit.

The supply device can be moved by means of a drive unit connected to it on the floor surface in or in the opposite direction to a possibly straight first direction of travel between a first and a second position, wherein the supply device is moved from the first to the second position by a movement in the first direction of travel. The supply device can be installed in a building, possibly on or in front of a wall, so that a rear wall of the supply device faces the wall. In this case, the first position is a retracted position and the second position is an extended position, which means that a front side of the supply device is arranged closer to the wall in the first position than in the second position. This has the advantage that the supply device requires less space in the first position and in the second position the distance that the floor cleaning machine has to travel to connect to the supply device can be reduced.

It is also conceivable that the supply device is installed in a room, wherein in this case the fresh water inlet and the waste water outlet are connected to the supply device via lines from the ceiling or floor of the room. This has the advantage that no wall is required to install the supply device and that it can thus be positioned freely.

As already mentioned, the supply device can be moved in or in the opposite direction to a possibly straight direction of travel. If the supply device is installed in front of a wall, the direction of travel is possibly perpendicular to the wall. The term “straight” means here that the supply device moves at a fixed angle to the wall, i.e., the direction does not change. This has the advantage that the supply device can always move straight towards the floor cleaning machine or straight away from the floor cleaning machine so that coupling can be as precise and time-efficient as possible.

The supply device may include a second coupling arrangement that can be connected to the first coupling arrangement, wherein the first direction of travel points in the direction in which the second coupling arrangement must be moved in order to be connected to the first coupling arrangement. The second coupling arrangement is designed in a manner complementary to the first coupling arrangement so that they can be connected to one another. The first direction of travel points in the direction in which the second coupling arrangement must be moved in order to be connected to the first coupling arrangement. If the supply device is installed on or in front of the wall, the first direction of travel points away from the wall.

The second coupling arrangement can be connected to a fresh water inlet, a waste water outlet and/or to a power supply. The supply device therefore can have a fresh water inlet, a waste water outlet and a power supply. The fresh water inlet can be connected to a water supply, for example of the building in which the supply device is used, for example via a line. In a similar manner, the waste water outlet can be connected to the drainage system of the building. Finally, the power supply can be connected to the power supply network of the building. In addition, it is possible that the supply device also has a cleaning solution tank.

The second coupling arrangement may have a socket complementary to the plug and a waste water collecting basin complementary to the waste water valve. The socket can have an interface for providing fresh water, which is connected to the fresh water inlet. The socket further can include an interface for providing electrical energy, which is connected to the power supply. The waste water collecting basin may be connected to the waste water outlet. Furthermore, the socket can have an interface for data transfer, which is connected to a control unit of the supply device and can be connected to the interface of the first coupling arrangement. This ensures that the supply device can exchange data with the floor cleaning machine and evaluate this data. In addition, an interface for providing cleaning solution can be provided, which is connected to a cleaning solution tank in the supply device.

It is further possible that the floor cleaning machine has a socket and the supply device has a plug complementary to the socket. Otherwise, the previous explanations with respect to the coupling arrangements apply analogously.

An embodiment of the method can comprise the following steps:

Actuating the supply device so that the supply device assumes the second position. The actuation of the supply device can generally be initiated by a variety of actions. On the one hand, the supply device can perform the actuation automatically after a predetermined period of time. This period of time can, for example, start from the time at which the supply device was decoupled from the floor cleaning machine. This has the advantage that the floor cleaning machine moves back to the second position after the predetermined period of time and is thus ready for coupling with the floor cleaning machine.

It is also conceivable that the supply device is actuated by a signal, possibly a wireless signal, from the floor cleaning machine. For this purpose, the floor cleaning machine can send the signal to the supply device so that it is actuated and moves to the second position. This has the advantage that the supply device can remain in the first, space-saving position until the floor cleaning machine sends the signal for actuation in order to couple with the supply device.

In a further alternative, the actuation can be performed by a user, for example by the user initiating the actuation of the supply device by pressing a button. The supply device can have an actuating button for this purpose. This variant is particularly advantageous if the supply device is to be coupled with a hand-operated floor cleaning machine or a ride-on machine, as the supply device can assume the first, space-saving position until the user performs the actuation and is thus only moved to the second position for coupling with the floor cleaning machine.

As already mentioned, the second position is the extended position. This means that the supply device is possibly fully extended and the floor cleaning machine has to travel a shorter distance in order to connect the coupling arrangements. In this case, it is possible that the second position is only assumed when the floor cleaning machine is already aligned with the supply device. In another alternative, the second position can be assumed immediately after the connection between the floor cleaning machine and the supply device or between their coupling arrangements has been released, when the floor cleaning machine has moved away from the supply device.

Moving the floor cleaning machine in the opposite direction to the first direction of travel, possibly by means of the chassis drive, so that the floor cleaning machine moves towards the supply device in such a manner that during the movement the first coupling arrangement points towards the second coupling arrangement. The movement of the floor cleaning machine is possibly a straight movement, analogous to the movement of the supply device. If the supply device and the floor cleaning machine each perform a straight movement, an efficient coupling can be achieved, as no evasive or corrective movements need to be performed. This has the advantage that the coupling is performed in a particularly simple and time-efficient manner.

Coupling the floor cleaning machine and the supply device by connecting the first coupling arrangement to the second coupling arrangement. Coupling of the first and second coupling arrangements can be understood as bringing the coupling arrangements into contact or achieving a coupled connection. For example, if the first coupling arrangement has a plug and the second coupling arrangement has a socket, coupling can be understood to mean that the plug has been fully received in the socket. With reference to the waste water valve and the waste water collecting basin, the term “coupling” is understood to mean that the waste water valve is arranged above or in the waste water collecting basin of the supply device in such a way that waste water drained from the waste water valve can be received completely by the waste water collecting basin. In this context, the supply device and floor cleaning machine can check electronically via an interface for sending and receiving data whether the coupling has taken place correctly by transmitting test signals.

Conveying fresh water from the fresh water inlet into the fresh water tank and/or conveying waste water from the waste water tank to the waste water outlet and/or charging the battery with the power supply. The conveying of fresh water, the conveying of waste water and the power supply or charging of the battery can take place either simultaneously or one after the other. It is also possible to convey waste water and/or fresh water several times. For example, the battery can be supplied with voltage first, as charging the battery usually takes the most time. At the same time, waste water can be conveyed from the waste water tank and fresh water into the fresh water tank. When the waste water tank is completely empty, it is preferable to flush the waste water valve. Flushing can be carried out with fresh water from the fresh water tank or via a separate flushing line in the second coupling arrangement, which is connected to the fresh water inlet. Then, when flushing with fresh water from the fresh water tank, the flushing of the waste water valve can be followed by conveying fresh water from the fresh water inlet into the fresh water tank again in order to fill it completely. Flushing via fresh water from the fresh water tank has the advantage that no separate flushing line is required in the second coupling arrangement. With a separate flushing line connected to the fresh water inlet, it is particularly advantageous that flushing can be performed independently of filling the fresh water tank.

Releasing the connection between the first and the second coupling arrangement by moving the supply device in the opposite direction to the first direction of travel from the second position to the first position. Releasing the connection between the first and the second coupling arrangement means that the coupling arrangements are brought out of contact so that the floor cleaning machine and the supply device are completely separated from one another. Moving the supply device from the second position to the first position means that the floor cleaning machine does not have to be moved for the step of releasing the connection. In particular, this means that the floor cleaning machine does not have to travel in reverse. This has the advantage, particularly in the case of autonomously operating floor cleaning machines, that it is not necessary to check whether there are objects or people behind the floor cleaning machine when it is to be released from the supply device. This makes it particularly easy and safe to release the floor cleaning machine from the supply device.

The method generally makes it possible for different types of floor cleaning machines to be coupled with the supply device. In particular, this includes autonomously operating floor cleaning machines that perform the method step of moving the floor cleaning machine in the opposite direction to the first direction of travel completely autonomously. For this purpose, the autonomously operating floor cleaning machine is moved in the opposite direction to the first direction of travel via a chassis drive. The method also comprises hand-operated floor cleaning machines and ride-on machines that are moved and/or controlled by a user. In this case, the method step of moving the floor cleaning machine in the opposite direction to the first direction of travel is carried out by the user by pushing or controlling the floor cleaning machine.

In one embodiment, after the connection is released, the floor cleaning machine performs a lateral pivoting movement about a vertical axis, in which the first coupling arrangement is laterally pivoted with respect to the second coupling arrangement. After release by moving the supply device in the opposite direction to the first direction of travel from the second position to the first position, the first and second coupling arrangements are separated from one another and the floor cleaning machine can move away from the supply device. As already mentioned, the movability of the supply device means that it is not necessary for the floor cleaning machine to move in reverse in order to release itself from the supply device. Rather, the present method makes it possible for the floor cleaning machine to perform a lateral pivoting movement. This makes it possible for the floor cleaning machine to move or pivot laterally to the supply device so that the supply device and the floor cleaning machine require less space when coupling and decoupling.

In another embodiment, the pivoting angle of the lateral pivoting movement is more than 90°, possibly 180°. A pivoting angle of 180° makes it possible for the floor cleaning machine to move in the direction of the first direction of travel of the supply device without having to reverse. This has the advantage that it is not necessary to check whether there are objects or people behind the floor cleaning machine after release. Instead, the floor cleaning machine can move forwards in a regular manner after pivoting by 180°.

In another embodiment, prior to the step of moving the floor cleaning machine in the opposite direction to the first direction of travel, the floor cleaning machine is positioned in front of the supply device such that the first coupling arrangement is aligned with the second coupling arrangement in such a manner that they can be connected by a straight movement towards one another. This step corresponds to positioning the floor cleaning machine in front of the supply device. The floor cleaning machine is positioned in front of the supply device such that the first and the second coupling arrangement are positioned opposite one another. In this regard, the floor cleaning machine can approach the supply device head-on or laterally and perform a pivoting movement until the first and the second coupling arrangement are positioned opposite one another. This has the advantage that less space is required for coupling as well.

In a further embodiment, after positioning, the floor cleaning machine moves exclusively in a straight movement in the opposite direction to the first direction of travel. This ensures that the floor cleaning machine can be coupled with the supply device regardless of the positioning carried out previously.

In a further embodiment, the movement in the opposite direction to the first direction of travel is interrupted for a time interval. The interruption allows the floor cleaning machine to check whether there are objects or people in the vicinity of the floor cleaning machine and, in particular, between the floor cleaning machine and the supply device that could interfere with the coupling process. The interruption can also be used to prepare the coupling process, for example by collecting or evaluating data from the floor cleaning machine. This allows for a safe and time-efficient coupling process to be achieved.

In a further manner, the movement in the opposite direction to the first direction of travel after the interruption is carried out at a reduced speed compared to the speed before the interruption. The reduced speed allows for a precise coupling.

In a further embodiment, the floor cleaning machine has a detection unit for detecting objects in the region of the first coupling arrangement, wherein during the movement of the floor cleaning machine in the opposite direction to the first direction of travel, the detection unit is used to check whether there are objects present between the floor cleaning machine and the supply device. If the detection unit detects an object in the vicinity of the supply device, the movement of the floor cleaning machine in the opposite direction to the first direction of travel is stopped. By checking for the presence of objects between the floor cleaning machine and the supply device, the coupling process can be prevented from being interrupted or disturbed, enabling a reliable coupling.

In a further embodiment, the first coupling arrangement has a waste water valve that is connected to the waste water tank, wherein the waste water valve has a closed position and an open position and can be transferred from the closed position to the open position by actuating an actuating element. When the waste water valve is in the open position and the first coupling arrangement is connected to the second coupling arrangement, waste water can be conveyed from the waste water tank to the waste water outlet. The supply device has an actuator that can engage with the actuating element when the first and the second coupling arrangement are connected, wherein in order to convey waste water from the waste water tank to the waste water outlet, the actuator engages with the actuating element and transfers the waste water valve to the open position. The actuator of the supply device can have a lifting cylinder that can assume a first position and a second position. In the first position, the lifting cylinder is retracted so that the waste water valve remains in the closed position when the first and the second coupling arrangement are connected. In the second position, the actuator presses against the actuating element of the waste water valve so that the waste water valve can be moved from the closed to the open position when the first and the second coupling arrangement are connected. This ensures that the waste water can be drained in a controlled manner by moving the actuator from the first to the second position. It is also conceivable that the actuator can assume further positions in addition to the first and second positions. For example, the actuator can also assume one or more intermediate positions. This has the advantage that the actuator can move the waste water valve to a position in which the waste water valve is not fully open. This has the advantage that the actuator can adjust the flow rate at the waste water valve by moving the waste water valve to an intermediate position in which the waste water valve is not fully open.

In a further embodiment, after conveying the waste water from the waste water tank to the waste water outlet, fresh water is supplied from the supply device to the waste water valve while the waste water valve is in the open position in order to flush the waste water valve. In order to supply fresh water to the waste water valve, the waste water valve can have a supply line from the fresh water tank of the floor cleaning machine so that the fresh water is supplied from the supply device to the fresh water tank and via the supply line to the waste water valve. However, it is also possible for the fresh water for flushing the waste water valve to be supplied by the supply device via the coupling arrangements. In this embodiment, the waste water valve can be flushed with fresh water in order to prevent dirt deposits from remaining on the valve, which could affect the tightness of the waste water valve.

In a embodiment, the level in the waste water tank is detected and fresh water is supplied, possibly from the supply device, to the waste water valve in order to flush the waste water valve when the level in the waste water tank has fallen below a minimum level. By detecting the level in the waste water tank, it is possible to recognize when the waste water tank is empty so that the waste water valve can then be flushed, as there is then no more waste water in the waste water tank and flowing through the waste water valve.

In one embodiment, while conveying fresh water from the fresh water inlet into the fresh water tank in the supply device, the amount of fresh water conveyed is detected, wherein, while conveying fresh water from the fresh water inlet into the fresh water tank, the level of the fresh water in the fresh water tank of the floor cleaning machine is detected and wherein the conveying of fresh water is stopped when the increase in the level in the fresh water tank does not correspond to the amount of fresh water conveyed as detected. By detecting the amount of fresh water dispensed and detecting the level, it is possible to determine whether the fresh water dispensed is being conveyed into the fresh water tank or whether fresh water is escaping so that the dispensing of fresh water is interrupted in order to prevent a larger amount of fresh water from escaping. The floor cleaning machine can send the level of the fresh water tank and the volume of the fresh water tank to the supply device via the data interface so that the supply device can calculate, possibly with a flow measurement, whether the amount of fresh water dispensed corresponds to the level in the fresh water tank as transmitted. It is also conceivable for the amount dispensed to be detected by means of a water meter.

In one embodiment, while conveying fresh water from the fresh water inlet into the fresh water tank in the supply device, the level of fresh water in the fresh water tank of the floor cleaning machine is detected and the conveying of fresh water is stopped when the level in the fresh water tank has reached a maximum level. Detecting the maximum level prevents too much fresh water from being conveyed into the fresh water tank of the floor cleaning machine. The maximum level can be sent to the supply device in the form of a value. Alternatively, the floor cleaning machine can send a stop command to the supply device so that the supply of fresh water can be stopped.

According to a second aspect, a system includes the features of claim 14. The system comprises a floor cleaning machine and a supply device and is designed to carry out the method according to the disclosure as described above.

Further features, advantages and possible applications of the present disclosure are apparent from the following description of the exemplary embodiments and the figures. All of the features described and/or illustrated form the subject matter of the disclosure by themselves and in any combination, also irrespective of their composition in the individual claims or their references. In the figures, identical reference signs further stand for identical or similar objects.

### DRAWINGS

In the following, the present disclosure is explained with reference to a drawing showing only a preferred exemplary embodiment, in which

FIGS. 1a and 1b show schematic views of an exemplary embodiment of a floor cleaning machine,

FIGS. 2a to 3b show schematic views of an exemplary embodiment of a supply device,

FIGS. 4 to 6d show schematic views of an exemplary embodiment of a system according to the disclosure with a floor cleaning machine shown in FIGS. 1a and 1b and a supply device shown in FIGS. 2a to 3b, and

FIG. 7 shows a schematic representation of an embodiment of a method.

### DETAILED DESCRIPTION

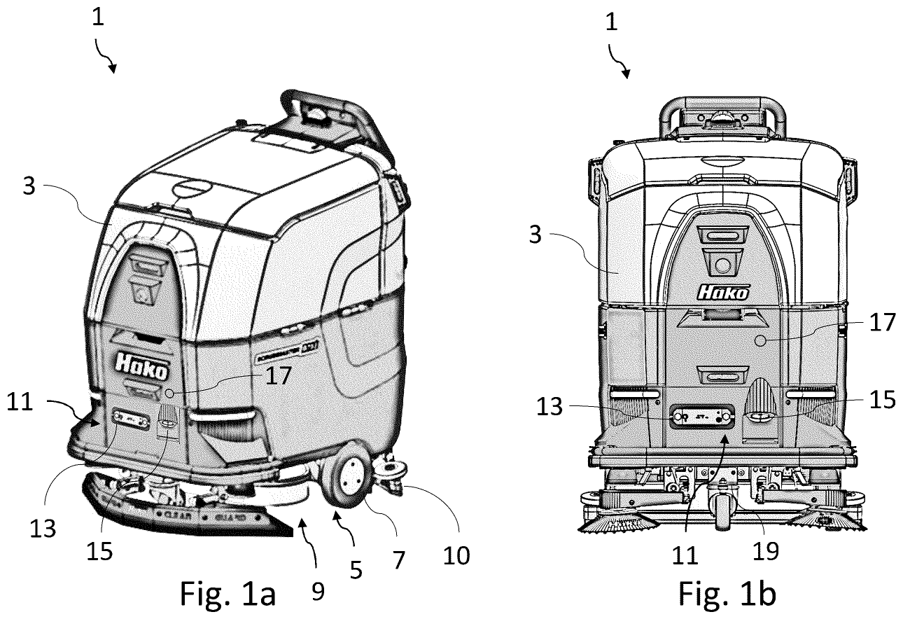

FIGS. 1a and 1b show a schematic view of an exemplary embodiment of a floor cleaning machine 1, wherein FIG. 1a shows a schematic perspective view of the exemplary embodiment of the floor cleaning machine 1 and FIG. 1b shows a schematic front view of the exemplary embodiment of the floor cleaning machine 1.

As can be seen from FIGS. 1a and 1b, the floor cleaning machine 1 has a first housing 3 and a chassis 5 that has at least one wheel 7, possibly driven by a chassis drive. The floor cleaning machine can be moved over a floor surface using the chassis 5. In particular, the floor cleaning machine 1 can be an autonomously operating cleaning robot. Furthermore, the floor cleaning machine 1 has a cleaning device 9, a fresh water tank and a waste water tank. In the present exemplary embodiment, the cleaning device 9 has a brush arrangement, a device for dispensing fresh water, optionally mixed with cleaning agents, and a suction pad 10, with which waste water can be absorbed from the floor surface. In an alternative embodiment, the cleaning device can have a wiping device. The brush arrangement is driven and engages with the floor surface in such a way that it loosens and/or removes dirt from the floor surface. The suction pad 10 is used to suck up dirt together with previously dispensed fresh water and guide it into the waste water tank. This makes it possible to clean floor surfaces with particularly heavy contamination in a very simple way.

The floor cleaning machine 1 has a first coupling arrangement 11. The first coupling arrangement 11 has a socket 13 and a waste water valve 15. The waste water valve 15 is connected to the waste water tank. The socket 13 has an interface for supplying fresh water to the fresh water tank, an interface for supplying fresh water to a flushing line for flushing the waste water valve 15, and an interface for supplying electrical energy that can be used to charge a battery of the floor cleaning machine 1. It is generally conceivable that the first coupling arrangement also has an interface for supplying further liquids, for example a cleaning solution, which can be conveyed into a tank for holding the cleaning solution in the floor cleaning machine 1. Furthermore, the socket 13 of the first coupling arrangement 11 has an interface for sending and receiving data, which is connected to a control unit of the floor cleaning machine 1 via a data bus. This enables the floor cleaning machine 1 to exchange data with a supply device or an external control unit.

Furthermore, the floor cleaning machine 1 has an actuating element 17 that is connected to the waste water valve 15. The waste water valve 15 has a closed position and an open position and can be transferred from the closed position to the open position by actuating the actuating element 17. In the closed position, the waste water is prevented from flowing out of the waste water tank. When the waste water valve 15 is in the open position, waste water can be conveyed out of the waste water tank via the waste water valve 15. This ensures that the waste water can be drained in a controlled manner by moving the waste water valve 15 from the closed to the open position using the actuating element 17.

The floor cleaning machine 1 has a threading plate 19, which engages with a complementarily formed threading device of a supply device and thus aligns the floor cleaning machine 1 with respect to the supply device. For this purpose, the threading plate 19 has a distal section that can engage with a recess of a supply device. The threading plate 19 has a smaller cross-section at the distal end so that the threading plate 19 can be threaded more easily on the supply device.

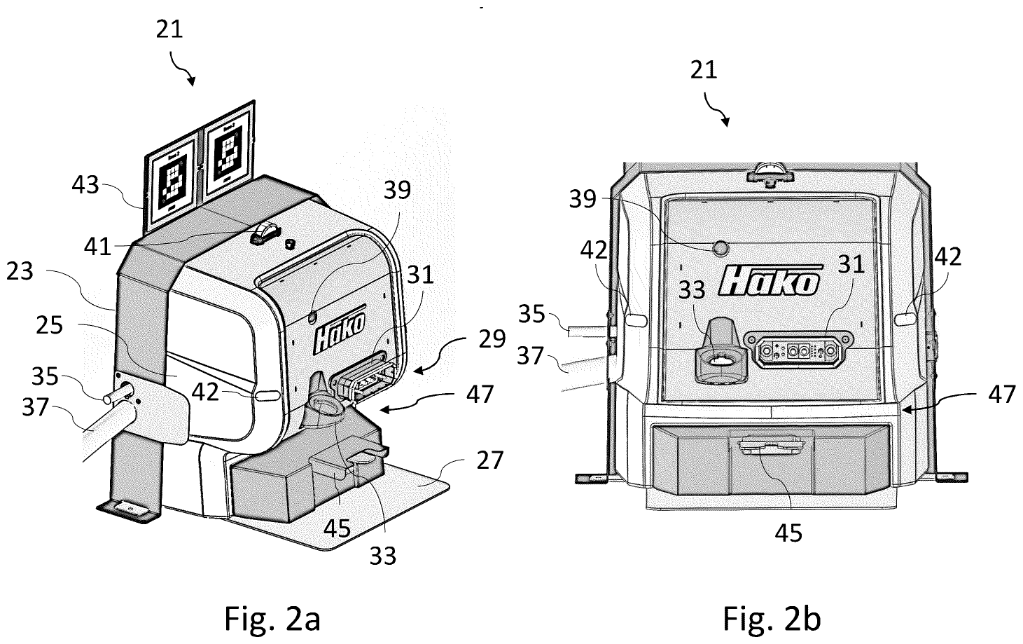

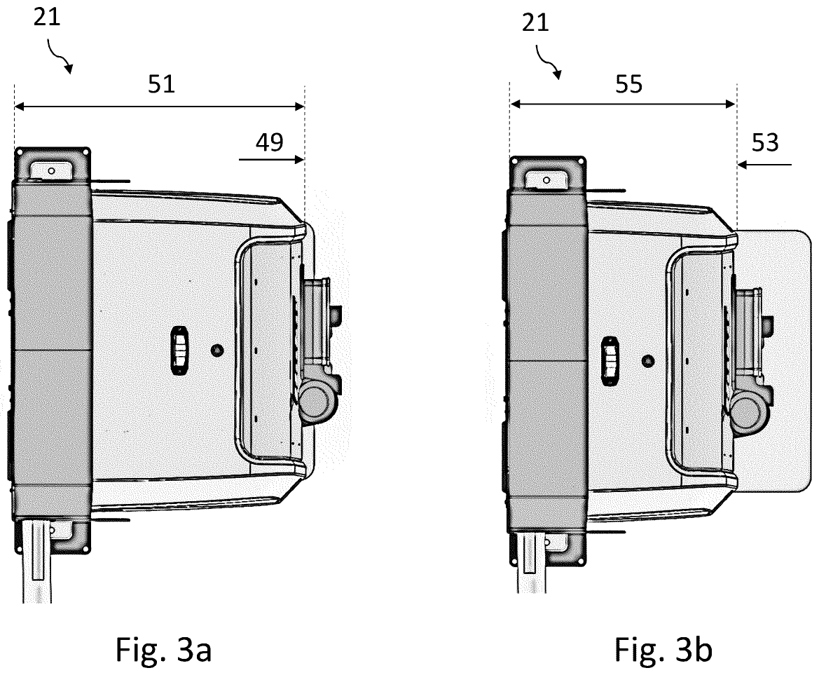

FIGS. 2a to 3b show a schematic view of an exemplary embodiment of a supply device 21, wherein FIG. 2a shows a schematic perspective view of the exemplary embodiment of the supply device 21 and FIG. 2b shows a schematic front view of the exemplary embodiment of the supply device 21.

As can be seen from FIGS. 2a and 2b, the supply device 21 can be inserted into a frame element 23 by moving a rear side of the supply device 21 into it. The frame element 23 can be permanently attached to a floor surface or to a wall. In addition, the supply device 21 has a second housing 25. In addition, a base plate 27 can be provided on which the supply device 21 moves.

The supply device 21 also has a drive unit by means of which the supply device 21 can be moved on the base plate 27 or a floor surface on which the supply device 21 is placed. The supply device 21 can be moved by means of the drive unit on the floor surface in or in the opposite direction to a possibly straight first direction of travel between a first and a second position, wherein the supply device 21 is moved from the first to the second position by a movement in the first direction of travel. The supply device 21 can be installed in a building, possibly on or in front of a wall, so that the rear wall of the frame element 23 can be fastened to the wall. In this case, the first position is a retracted position and the second position is an extended position, which means that a front side of the supply device 21 is arranged closer to the wall in the first position than in the second position. This has the advantage that the supply device 21 requires less space in the first position and in the second position the distance that the floor cleaning machine 1 has to travel to connect to the supply device 21 can be reduced.

Furthermore, the supply device 21 has a second coupling arrangement 29, which has a plug 31 complementary to the socket 13 and a waste water collecting basin 33 complementary to the waste water valve 15. In the present embodiment, the plug 31 and the waste water collecting basin 33 are separated from one another, that is, they are arranged at a distance from one another. In an alternative embodiment, the plug 31 and the waste water collecting basin 33 can be arranged integrally, i.e., in one component. This has the advantage that the second coupling arrangement 29 requires less space.

The second coupling arrangement 29 is connected to a fresh water inlet 35, a waste water outlet 37 and to a power supply. It is also possible that the second coupling arrangement 29 is connected to a tank with cleaning solution and the plug 31 has an interface for providing the cleaning solution. The plug 31 has an interface for providing fresh water, which is connected to the fresh water inlet 35. Furthermore, the plug 31 has an interface for providing electrical energy, which is connected to the power supply. The waste water collecting basin 33 is connected to the waste water outlet 37. Furthermore, the plug 31 has an interface for data transfer, which is connected to a control unit of the supply device 21 and can be connected to the interface of the first coupling arrangement 11. This ensures that the supply device 21 can exchange data with the floor cleaning machine 1 and evaluate this data.

The supply device 21 has an actuator 39 that can engage with the actuating element 17 when the first and the second coupling arrangement 11, 29 are connected, wherein in order to convey waste water from the waste water tank to the waste water outlet 37, the actuator 39 engages with the actuating element 17 and transfers the waste water valve 15 to the open position. The actuator 39 of the supply device 21 is designed as a lifting cylinder that can assume a first position and a second position. In the first position, the lifting cylinder is retracted so that the waste water valve 15 remains in the closed position when the first and the second coupling arrangement 11, 29 are connected. In the second position, the actuator 39 presses against the actuating element 17 of the waste water valve 15 so that the waste water valve 15 can be moved from the closed to the open position when the first and the second coupling arrangement 11, 29 are connected.

The supply device 21 has a light unit 41. The light unit 41 is used to emit a visual warning signal when the supply device 21 is moved. Possibly, the light unit 41 flashes when the supply device 21 is moved from the first position to the second position and from the second position to the first position. The warning signal emitted by the light unit 41 can be used to warn people that the supply device 21 is being moved.

Furthermore, the supply device 21 has an LED arrangement with at least one LED light 42. In the present exemplary embodiment, two LED lights 42 are arranged, one to each side of the supply device 21. The LED lights 42 are capable of lighting up in a variety of colors so that the LED light 42 can indicate a status by lighting up in a particular color. For example, the LED light 42 can light up in a first color, for example blue, to indicate that the system is in an autonomously operating state. The autonomously operating state is understood to mean that the supply device 21 acts autonomously, i.e., that it actuates itself, meaning that it extends and retracts by itself. This condition is particularly advantageous when the supply device 21 is used with an autonomously operating floor cleaning machine 1. In contrast, the LED light 42 can light up in a second color, for example green, to indicate that the supply device 21 is in a manually operating state. A manually operating state is understood to mean that the supply device 21 does not extend and retract automatically, but only extends when a user has actuated the supply device 21. This condition is particularly advantageous when the supply device 21 is used with a manually operated floor cleaning machine 1. Furthermore, the LED light 42 can light up in a third color, for example red, to indicate that there is a fault. The fault may be a fault or error in the supply device 21 or a fault during coupling with the floor cleaning machine 1.

It is also conceivable that the LED light 42 lights up in a fourth color to indicate that it is exchanging data with the floor cleaning machine 1, possibly when it is coupled with the floor cleaning machine 1. This exchange of data can comprise sending data, for example when the supply device 21 sends data to the floor cleaning machine 1. Such data can comprise, for example, fault data, operational data or other information about the supply device 21. The exchange of data can also comprise receiving data, for example when the supply device 21 receives data from the floor cleaning machine 1. Such data can comprise, for example, information about the floor cleaning machine 1 or updates to the software of the supply device 21. Generally, the floor cleaning machine 1 has an interface for communication, for example with a server. Due to the exchange of information with the supply device 21, it is not necessary for the supply device to also have an interface for communication, but it can instead communicate via the floor cleaning machine 1, for example with the server. For example, it is possible for the floor cleaning machine 1 to receive an error log from the supply device 21 and send it to the server or to receive update data from the server for the supply device 21 and forward it to the latter. This makes the supply device 21 particularly easy to maintain.

Furthermore, the supply device 21 has an identification tag 43. The identification tag 43 can be read by the floor cleaning machine 1. By means of the identification tag 43, the floor cleaning machine 1 can verify the supply device 21 and check whether the supply device 21 is compatible with the floor cleaning machine 1.

The supply device 21 has a threading unit 45 that can engage with the threading plate 19 of the floor cleaning machine 1 to align the supply device 21 with respect to the floor cleaning machine 1. For this purpose, the threading unit 45 has a recess which possibly has a conical shape, i.e., the recess widens in the direction away from the supply device 21. The threading unit 45 makes it particularly easy to achieve a correct alignment of the supply device 21 with respect to the floor cleaning machine 1 so that the supply device 21 is always correctly aligned with respect to the floor cleaning machine 1. This makes it possible to achieve a particularly reliable coupling of the floor cleaning machine 1 with the supply device 21.

Above the threading unit 45, the supply device 21 has a recess 47, which serves to allow the floor cleaning machine 1 to fully approach the supply device 21. On the one hand, the floor cleaning machine 1 can have sections that can protrude and be received in the recess 47 when the floor cleaning machine 1 approaches the supply device 21 for coupling. On the other hand, the recess 47 can be used to ensure that a detection device of the floor cleaning machine 1 with a detection field, which possibly lies in a plane with the recess 47, does not recognize the supply device 21 as an obstacle and thus prevents the floor cleaning machine 1 from moving close enough to the supply device 21 to couple with it. For example, if the floor cleaning machine 1 has a laser protection field, then the recess 47 serves to receive the laser protection field so that the floor cleaning machine 1 can be coupled with the supply device 21 without the laser protection field recognizing the supply device 21 as an obstacle. This has the advantage that the floor cleaning machine 1 does not have to switch off the detection device even if it couples with the supply device 21. In addition, the floor cleaning machine 1 can start the detection device in preparation for decoupling from the supply device 21 when the floor cleaning machine 1 is still coupled with the supply device 21.

FIGS. 3a and 3b show a schematic top view of the embodiment of the supply device 21, wherein FIG. 3a shows the supply device 21 in the second position and FIG. 3b shows the supply device 21 in the first position. As already mentioned, the second position is the extended position, which means that the supply device 21 has been moved by a movement in a first direction of travel 49. In the second position, a front side of the supply device 21 is located at a first distance 51 from the rear side of the frame element 23. In the first, retracted position, i.e., the supply device 21 has been moved by a movement in a second direction of travel 53 opposite to the first direction of travel 49. In the first position, the front side of the supply device 21 is located at a second distance 55 from the rear side of the frame element 23. In this regard, the first distance 51 is greater than the second distance 55 so that the supply device 21 requires less space in the first position and in the second position the distance that the floor cleaning machine 1 has to travel to connect to the supply device 21 is reduced.

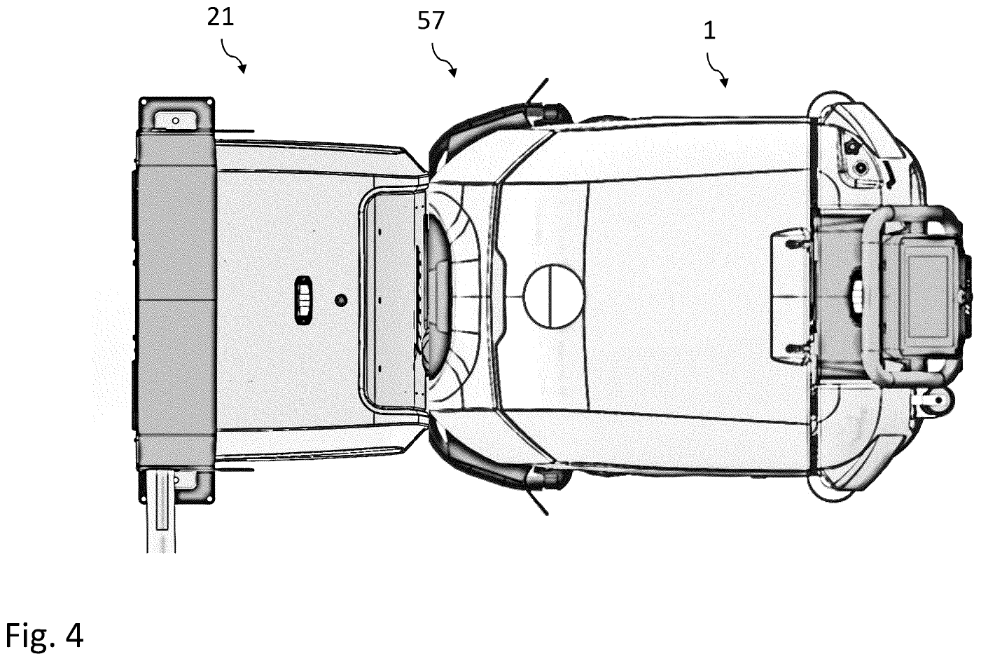

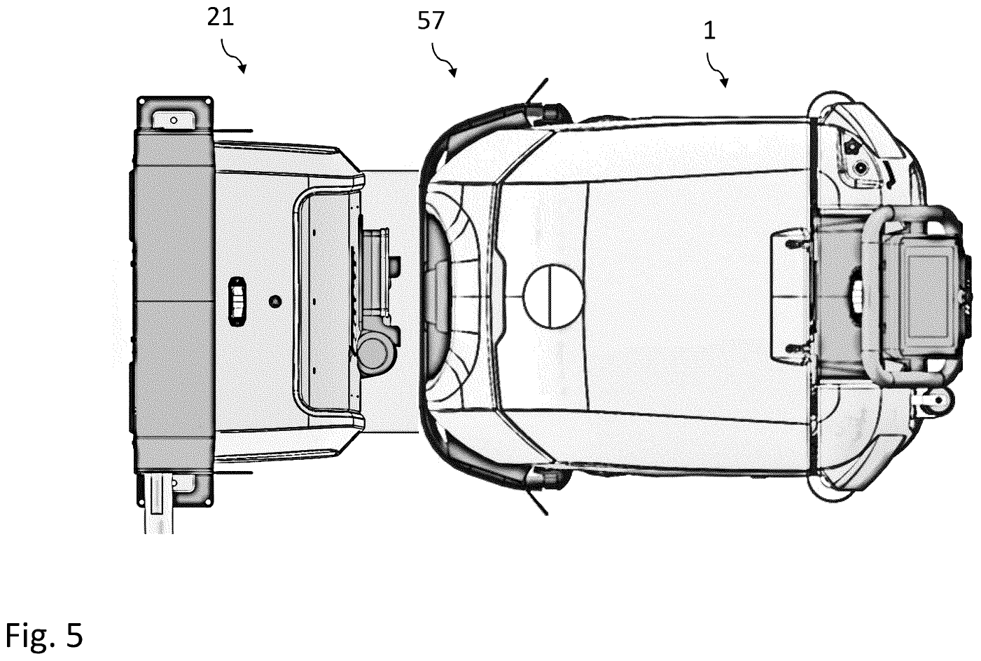

FIGS. 4 to 6d show schematic views of an embodiment of a system 57 according to the disclosure with a floor cleaning machine 1 shown in FIGS. 1a and 1b and a supply device 21 shown in FIGS. 2a to 3b, wherein FIG. 4 shows the system 57 in a decoupled state and FIG. 5 shows the system 57 in a coupled state.

FIG. 4 shows the system 57 comprising the floor cleaning machine 1 and the supply device 21 in a coupled state, which means that the supply device 21 is in the second, extended position and the floor cleaning machine 1 is coupled with the supply device 21 in such a way that the first coupling arrangement 11 and the second coupling arrangement 29 are connected to one another.

FIG. 5 shows the system 57 comprising the floor cleaning machine 1 and the supply device 21 in a decoupled state, which means that the supply device 21 is in the first, retracted position and the floor cleaning machine 1 is decoupled from the supply device 21 in such a way that the first coupling arrangement 11 and the second coupling arrangement 29 are released from one another and spaced apart.

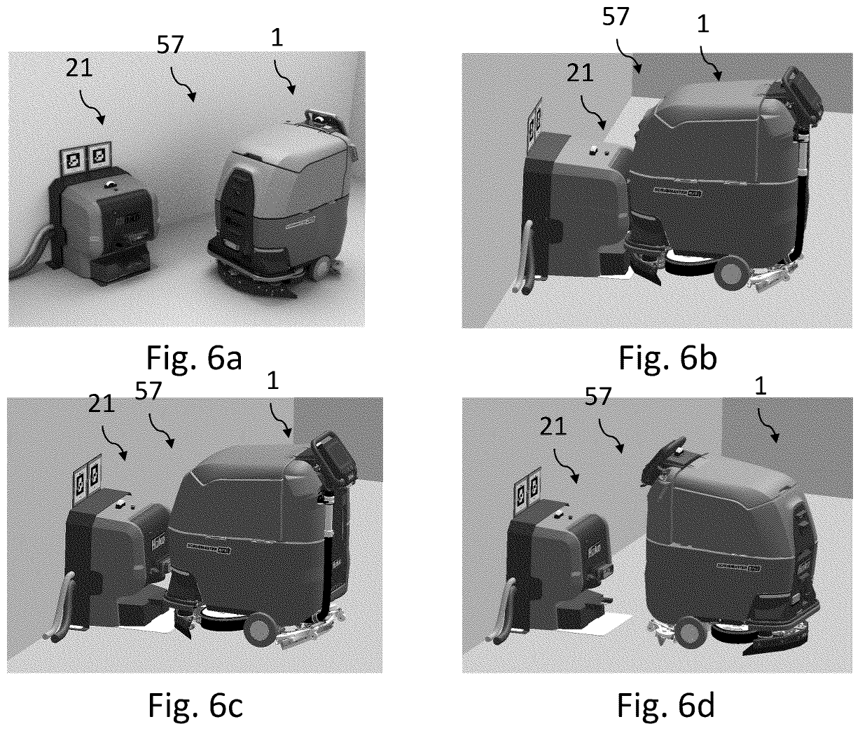

FIGS. 6a to 6d show the system 57 in four different states. In FIG. 6a, the floor cleaning machine 1 and the supply device 21 are shown, wherein the floor cleaning machine 1 and the supply device 21 are not positioned relative to one another so as to couple with one another. This state corresponds, for example, to a state in which the floor cleaning machine 1 is carrying out a cleaning job and the supply device 21 is in a waiting state. In the waiting state, the supply device 21 waits for the floor cleaning machine 1 to couple with the supply device 21. In the waiting state, the supply device 21 is in the second, extended position. On the one hand, this has the advantage that it is not necessary to check whether the supply device 21 is extended and thus ready for coupling and, on the other hand, the supply device 21 does not have to be extended when the floor cleaning machine 1 approaches it in order to couple with it.

In FIG. 6b, the system 57 is shown in a coupled state, as in FIG. 4. The supply device 21 is still in the second position and the floor cleaning machine 1 has approached the supply device 21 in such a way that the first and the second coupling arrangement 11, 29 are connected to one another. In the coupled state, the floor cleaning machine 1 and the supply device 21 can, on the one hand, exchange or supply and drain the fresh and waste water and, on the other hand, the battery of the floor cleaning machine 1 can be charged. Furthermore, the floor cleaning machine 1 and the supply device 21 can exchange information in the form of data via the data interface.

In FIG. 6c, the system 57 is shown in a decoupled state, as in FIG. 5. For this purpose, the supply device 21 was moved to the first position so that it is now retracted. The floor cleaning machine 1 was not moved in order to release the connection. In the decoupled state, the floor cleaning machine 1 can now move away from the supply device 21, for example in the form of a pivoting movement. As previously mentioned, the floor cleaning machine 1 can start the detection device even before the supply device 21 has been moved to the first position. This has the advantage that the floor cleaning machine 1 can pivot immediately after the supply device 21 has been decoupled from the floor cleaning machine 1 and obstacles are immediately detected during pivoting.

In FIG. 6d, the system 57 is shown in a decoupled state, wherein the floor cleaning machine 1 has performed a pivoting movement by 180° in order to move away from the supply device 21. The supply device 21 is in the first position and is thus retracted. After decoupling, the floor cleaning machine 1 can carry out a cleaning job and the supply device 21 can move to the second position and assume the waiting position so that the state shown in FIG. 6a is assumed again.

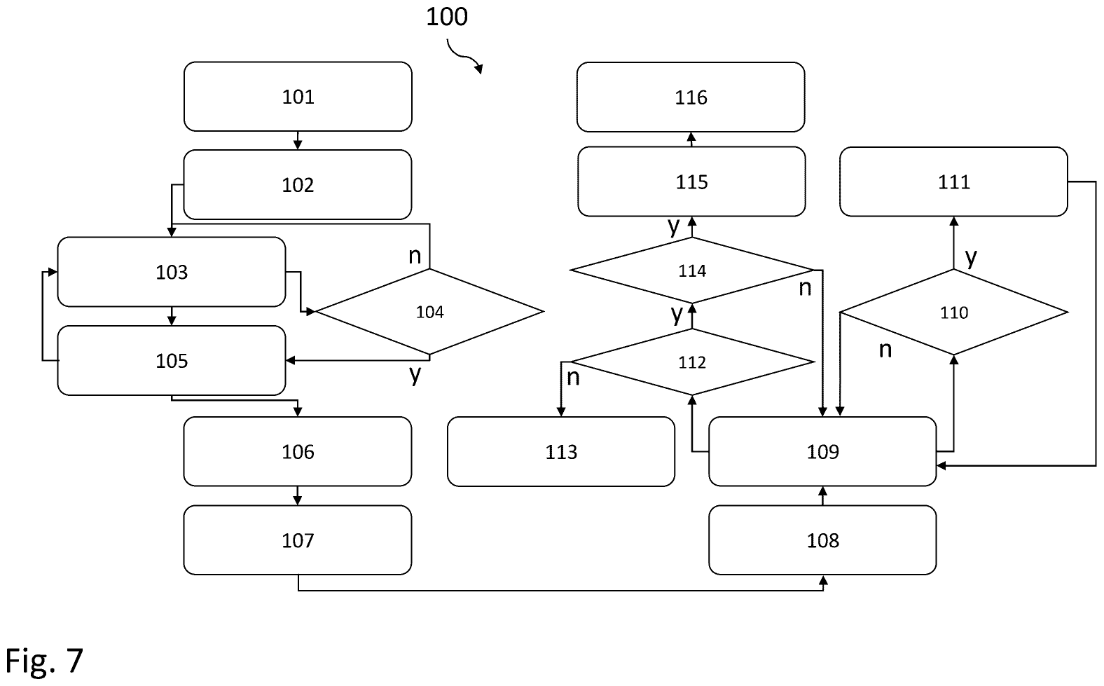

FIG. 7 shows a schematic representation of an embodiment of a method 100 according to the disclosure. The method 100 concerns operating the system 57 comprising the floor cleaning machine 1 and the supply device 21.

In a first step 101, the method 100 comprises actuating the supply device 21 so that the supply device 21 assumes the second position. As already mentioned, the second position is the extended position. This means that the supply device 21 is possibly fully extended and the floor cleaning machine 1 has to travel a shorter distance in order to connect the coupling arrangements 11, 29. In this case, it is possible that the second position is only assumed when the floor cleaning machine 1 is already aligned with the supply device 21. In another alternative, the second position can already be assumed immediately or with a delay after a predetermined period of time has elapsed, after a previous release of the connection between the floor cleaning machine 1 and the supply device 21 or between their coupling arrangements 11, 29, when the floor cleaning machine 1 has moved away from the supply device 21, as shown in FIG. 6d. It is also conceivable that the supply device 21 is actuated by a signal, possibly a wireless signal, from the floor cleaning machine 1. Finally, the actuation can be performed by a user, for example by the user initiating the actuation of the supply device 21 by pressing a button. The supply device 21 can have an actuating button for this purpose. This variant is particularly advantageous if the supply device 21 is to be coupled with a hand-operated floor cleaning machine 1 or a ride-on machine

In the preferred embodiment described herein, the method 100 comprises, in a second step 102, positioning the floor cleaning machine 1 in front of the supply device 21 such that the first coupling arrangement 11 is aligned with the second coupling arrangement 29 in such a manner that they can be connected by a straight movement towards one another. This step corresponds to positioning the floor cleaning machine 1 in front of the supply device 21. The floor cleaning machine 1 is positioned in front of the supply device 21 such that the first and the second coupling arrangement 11, 29 are positioned opposite one another. In this regard, the floor cleaning machine 1 can approach the supply device 21 head-on or laterally and perform a pivoting movement until the first and the second coupling arrangement 11, 29 are positioned opposite one another. This has the advantage that less space is required for coupling as well.

In a third step 103, the method 100 comprises moving the floor cleaning machine 1 in the opposite direction to the first direction of travel 49 by means of the chassis drive so that the floor cleaning machine 1 moves towards the supply device 21 in such a manner that during the movement the first coupling arrangement 11 points towards the second coupling arrangement 29. The movement of the floor cleaning machine 1 is possibly a straight movement, analogous to the movement of the supply device 21. If the supply device 21 and the floor cleaning machine 1 each perform a straight movement, an efficient coupling can be achieved, as no evasive or corrective movements need to be performed. This has the advantage that the coupling is performed in a particularly simple and time-efficient manner.

In the preferred embodiment described herein, the method 100 comprises, in a fourth step 104, detecting objects in the region of the second coupling arrangement 11, i.e., between the floor cleaning machine 1 and the supply device 21, by means of a detection unit, wherein, during the movement of the floor cleaning machine 1 in the opposite direction to the first direction of travel 49 in the third step 103, the detection unit is used in the fourth step 104 to check whether there are objects present between the floor cleaning machine 1 and the supply device 21. If the detection unit detects an object in the vicinity of the supply device 21 (path y), the movement of the floor cleaning machine 1 in the opposite direction to the first direction of travel 49 is stopped. If the detection unit does not detect an object or a person in the vicinity of the supply device 21 (path n), the floor cleaning machine 1 continues to move. By checking for the presence of objects between the floor cleaning machine 1 and the supply device 21, the coupling process can be prevented from being interrupted or disturbed, enabling a reliable coupling.

In a preferred embodiment, the third step 103 and the fourth step 104 can be performed in parallel in that the floor cleaning machine 1 checks whether there are objects present between the floor cleaning machine 1 and the supply device 21 whenever it is moving. In a further preferred embodiment, the fourth step 104 can also be performed in parallel with the second and third steps 102, 103. This has the advantage that the floor cleaning machine 1 also checks during positioning whether there are objects present between the floor cleaning machine 1 and the supply device 21. This ensures that the second step of positioning can also be carried out reliably.

In the preferred embodiment described herein, the method 100 comprises, in a fifth step 105, stopping or interrupting the movement in the opposite direction to the first direction of travel 49 for a time interval. The interruption allows the floor cleaning machine 1 to check whether there are objects or people in the vicinity of the floor cleaning machine 1 and, in particular, between the floor cleaning machine 1 and the supply device 21 that could interfere with the coupling process. The interruption can also be used to prepare the coupling process, for example by collecting or evaluating data from the floor cleaning machine 1. This allows for a safe and time-efficient coupling process to be achieved.

The fifth step 105 can be performed either following the check in the fourth step 104, specifically if objects are located between the floor cleaning machine 1 and the supply device 21, or when a predetermined distance is reached between the floor cleaning machine 1 and the supply device 21. This ensures that the floor cleaning machine 1 is not only stopped when objects are present between the floor cleaning machine 1 and the supply device 21, but also when the predetermined distance is reached. This has the advantage that the floor cleaning machine 1 comes to a standstill before coupling with the supply device 21 and can prepare for the coupling process so that a safe and time-efficient coupling process is achieved.

Then, when the interruption of the movement as a result of the detection of an object has occurred in the fifth step 105, the method 100 can continue with the third step 103 so that the floor cleaning machine 1 continues to move towards the supply device 21 until a certain condition is met, for example the predetermined distance is reached. This has the advantage that after an interruption caused by a detected object, the floor cleaning machine 1 can continue with the method at the point where the interruption occurred. This ensures that the method 100 does not have to start over when an object is detected.

In the embodiment described herein, the method 100 comprises, in a sixth step 106, moving the floor cleaning machine 1 in the opposite direction to the first direction of travel 49 at a reduced speed compared to the speed before the interruption. This means that the floor cleaning machine 1 is moved towards the supply device 21 at a lower speed in the sixth step 106 than in the third step 103. The reduced speed allows for a precise coupling.

In a seventh step 107, the method 100 comprises coupling the floor cleaning machine 1 and the supply device 21 by connecting the first coupling arrangement 11 to the second coupling arrangement 29, as shown in FIG. 6b. Coupling of the first and second coupling arrangements 11, 29 can be understood as bringing the coupling arrangements 11, 29 into contact or achieving a coupled connection. For example, if the first coupling arrangement 11 has a socket 13 and the second coupling arrangement has a plug 31, coupling can be understood to mean that the plug 31 has been fully received in the socket 13. With reference to the waste water valve 15 and the waste water collecting basin 33, the term “coupling” is understood to mean that the waste water valve 15 is arranged above or in the waste water collecting basin 33 of the supply device 21 in such a way that waste water drained from the waste water valve 15 can be received completely by the waste water collecting basin 33. In the seventh step 107, an electronic check can be performed to determine whether the supply device 21 has successfully coupled with the floor cleaning machine 1.

In the embodiment described herein, the method 100 comprises, in an eighth step 108, an actuation of the actuating element 17, wherein the waste water valve 15 is thereby transferred from the closed position to the open position. When the waste water valve 15 is in the open position and the first coupling arrangement 11 is connected to the second coupling arrangement 29, waste water can be conveyed from the waste water tank to the waste water outlet 37. The supply device 21 has the actuator 39 that can engage with the actuating element 17 when the first and the second coupling arrangement 11, 29 are connected, wherein in order to convey waste water from the waste water tank to the waste water outlet 37, the actuator 39 engages with the actuating element 17 and transfers the waste water valve 15 to the open position.

In a ninth step 109, the method 100 comprises conveying fresh water from the fresh water inlet 35 into the fresh water tank and/or conveying waste water from the waste water tank to the waste water outlet 37 and/or charging the battery with the power supply. Alternatively or in addition, it is possible that other liquids, for example a cleaning solution, are also conveyed in the ninth step 109. The conveying of fresh water, the conveying of waste water and the power supply or charging of the battery can take place either simultaneously or one after the other. It is also possible to convey waste water and/or fresh water several times. For example, the battery can be supplied with voltage first, as charging the battery usually takes the most time. At the same time, waste water can be conveyed from the waste water tank and fresh water into the fresh water tank. When the waste water tank is completely empty, it is preferable to flush the waste water valve 15. Flushing the waste water valve 15 can then be followed by conveying fresh water from the fresh water inlet 35 into the fresh water tank again in order to fill it completely once the waste water valve 15 has been flushed with fresh water from the fresh water tank. It is not necessary to convey fresh water from the fresh water inlet 35 again if the waste water valve 15 has been flushed with fresh water from the fresh water inlet 35.

In the embodiment described herein, the method 100 comprises, in a tenth step 110, detecting a level in the waste water tank, wherein fresh water is supplied from the supply device 21 to the waste water valve 15 in order to flush the waste water valve 15 when the level in the waste water tank has fallen below a minimum level. By detecting the level in the waste water tank, it is possible to recognize when the waste water tank is empty so that the waste water valve 15 can then be flushed, as there is then no more waste water in the waste water tank and flowing through the waste water valve 15.

In the embodiment described herein, the method 100 comprises, in an eleventh step 111, flushing the waste water valve 15 by supplying fresh water from the supply device 21 to the waste water valve 15 while the waste water valve 15 is in the open position. In order to supply fresh water to the waste water valve 15, the waste water valve 15 has a supply line from the first coupling arrangement 11 so that fresh water is supplied from the supply device 21 to the waste water valve 15 via the supply line. In this embodiment, the waste water valve 15 can be flushed with fresh water in order to prevent dirt deposits from remaining on the valve, which could affect the tightness of the waste water valve 15. The eleventh step 111 can be followed again by the ninth step 109 to fill the fresh water tank. This is the case when the fresh water for flushing the waste water valve 15 is conveyed from the fresh water tank. For this purpose, the supply line to the waste water valve 15 can be connected to the fresh water tank.

In the embodiment described herein, the method 100 comprises, in a twelfth step 112, detecting the amount of fresh water conveyed, wherein, while conveying fresh water from the fresh water inlet into the fresh water tank in the ninth step 109, the amount of fresh water conveyed is detected in the supply device 21 and the level of the fresh water in the fresh water tank of the floor cleaning machine 1 is detected, wherein the conveying of fresh water is stopped when the increase in the level in the fresh water tank does not correspond to the amount of fresh water conveyed as detected. By detecting the amount of fresh water dispensed and detecting the level, it is possible to determine whether the fresh water dispensed is being conveyed into the fresh water tank or whether fresh water is escaping so that the dispensing of fresh water is interrupted in order to prevent a larger amount of fresh water from escaping. The floor cleaning machine 1 can send the level of the fresh water tank and the volume of the fresh water tank to the supply device 21 via the data interface so that the supply device 21 can calculate whether the amount of fresh water dispensed corresponds to the level in the fresh water tank as transmitted.

If it is detected in the twelfth step 112 that the increase in the level in the fresh water tank does not correspond to the amount of fresh water conveyed as detected (path n), the supply of fresh water is stopped in a thirteenth step 113. The thirteenth step 113 comprises an output and reporting of an error so that it can be checked whether and where the fresh water is escaping. If it is detected in the twelfth step 112 that the increase in the level in the fresh water tank corresponds to the amount of fresh water conveyed as detected (path y), the method 100 proceeds to the next step.

In the embodiment described herein, the method 100 comprises, in a fourteenth step 114, detecting in the supply device 21 the level of fresh water in the fresh water tank, wherein the conveying of fresh water is stopped when the level in the fresh water tank has reached a maximum level. Detecting the maximum level prevents too much fresh water from being conveyed into the fresh water tank of the floor cleaning machine 1. The maximum level can be sent to the supply device 21 in the form of a value. Alternatively, the floor cleaning machine 1 can send a stop command to the supply device 21 so that the supply of fresh water can be stopped.

In a fifteenth step 115, the method 100 comprises releasing the connection between the first and the second coupling arrangement 11, 29 by moving the supply device 21 in the opposite direction to the first direction of travel 49 from the second position to the first position. Releasing the connection between the first and the second coupling arrangement 11, 29 means that the coupling arrangements 11, 29 are brought out of contact so that the floor cleaning machine 1 and the supply device 21 are completely separated from one another. Moving the supply device 21 from the second position to the first position means that the floor cleaning machine 1 does not have to be moved for the step of releasing the connection. In particular, this means that the floor cleaning machine 1 does not have to travel in reverse. This has the advantage that it is not necessary to check whether there are objects or people behind the floor cleaning machine 1 when it is to be released from the supply device 21. This makes it particularly easy and safe to release the floor cleaning machine 1 from the supply device 21.

In the embodiment described herein, the method 100 comprises, in a sixteenth step 116, pivoting the floor cleaning machine 1 by a lateral pivoting movement of the floor cleaning machine 1 about a vertical axis, in which the first coupling arrangement 11 is laterally pivoted with respect to the second coupling arrangement 29. After release by moving the supply device 21 in the opposite direction to the first direction of travel 49 from the second position to the first position in the fifteenth step 115, the first and second coupling arrangements 11, 29 are separated from one another and the floor cleaning machine 1 can move away from the supply device 21. As already mentioned, the movability of the supply device 21 means that it is not necessary for the floor cleaning machine 1 to move in reverse in order to release itself from the supply device 21. Rather, the present method 100 makes it possible for the floor cleaning machine 1 to perform a lateral pivoting movement. This makes it possible for the floor cleaning machine 1 to move or pivot laterally to the supply device 21 so that the supply device 21 and the floor cleaning machine 1 require less space when coupling and decoupling.

The pivoting angle of the lateral pivoting movement is possibly more than 90°, possibly 180°. A pivoting angle of 180° makes it possible for the floor cleaning machine 1 to move in the direction of the first direction of travel 49 of the supply device 21 without having to reverse. This has the advantage that it is not necessary to check whether there are objects or people behind the floor cleaning machine 1 after release. Instead, the floor cleaning machine 1 can move forwards in a regular manner after pivoting by 180°.

In addition, it should be noted that the terms “comprise/have” do not exclude other elements or steps and “one” or “a” does not exclude a plurality. Furthermore, it should be noted that features described with reference to one of the above exemplary embodiments may also be used in combination with other features of other exemplary embodiments described above. Reference signs stated in the claims are not to be regarded as a limitation.

### LIST OF REFERENCE SIGNS

1 Floor cleaning machine
3 First housing
5 Chassis
7 Wheel
9 Cleaning device
10 Suction pad
11 First coupling arrangement
13 Socket
15 Waste water valve
17 Actuating element
19 Threading plate
21 Supply device
23 Frame element
25 Second housing
27 Base plate
29 Second coupling arrangement
31 Plug
33 Waste water collecting basin
35 Fresh water inlet
37 Waste water outlet
39 Actuator
41 Light unit
42 LED lights
43 Identification tag
45 Threading unit
47 Recess
49 First direction of travel
51 First distance
53 Second direction of travel
55 Second distance
57 System
100 Method
101 First step
102 Second step
103 Third step
104 Fourth step
105 Fifth step
106 Sixth step
107 Seventh step
108 Eighth step
109 Ninth step
110 Tenth step
111 Eleventh step
112 Twelfth step
113 Thirteenth step
114 Fourteenth step
115 Fifteenth step
116 Sixteenth step

1. A method for operating a system comprising a floor cleaning machine and a supply device,
wherein the floor cleaning machine has a chassis with at least one wheel that is driven by a chassis drive, wherein the chassis is designed in such a way that the floor cleaning machine can be moved over a floor surface,
wherein the floor cleaning machine has at least one cleaning device that is designed to engage with the floor surface,
wherein the floor cleaning machine has a fresh water tank for holding fresh water, a waste water tank for holding waste water and/or a rechargeable battery for supplying power to the floor cleaning machine and a first coupling arrangement,
wherein the fresh water tank, the waste water tank and/or the battery are connected to the first coupling arrangement;
wherein the supply device can be moved by means of a drive unit connected to it on the floor surface in or in the opposite direction to a straight first direction of travel between a first and a second position,
wherein the supply device is moved from the first to the second position by a movement in the first direction of travel,
wherein the supply device has a second coupling arrangement that can be connected to the first coupling arrangement, and wherein the first direction of travel points in the direction in which the second coupling arrangement must be moved in order to be connected to the first coupling arrangement,
wherein the second coupling arrangement is connected to a fresh water inlet, a waste water outlet and/or to a power supply,
wherein the supply device and the floor cleaning machine are designed in such a way that, when the first and the second coupling arrangement are connected to one another, fresh water can be conveyed from the fresh water inlet into the fresh water tank and/or waste water can be conveyed from the waste water tank to the waste water outlet and/or the battery is connected to the power supply,
wherein the method comprises the following steps:
actuating the supply device so that the supply device assumes the second position,
moving the floor cleaning machine in the opposite direction to the first direction of travel by means of the chassis drive, so that the floor cleaning machine moves towards the supply device in such a manner that during the movement the first coupling arrangement points towards the second coupling arrangement,
coupling the floor cleaning machine and the supply device by connecting the first coupling arrangement to the second coupling arrangement,
conveying fresh water from the fresh water inlet into the fresh water tank and/or conveying waste water from the waste water tank to the waste water outlet and/or charging the battery with the power supply,
releasing the connection between the first and the second coupling arrangement by moving the supply device in the opposite direction to the first direction of travel from the second position to the first position.

2. The method for operating a system according to claim 1, wherein after the connection is released, the floor cleaning machine performs a lateral pivoting movement about a vertical axis, in which the first coupling arrangement is laterally pivoted with respect to the second coupling arrangement.

3. The method for operating a system according to claim 2, wherein the pivoting angle of the lateral pivoting movement is more than 90°.

4. The method for operating a system according to claim 1, wherein, prior to the step of moving the floor cleaning machine in the opposite direction to the first direction of travel, the floor cleaning machine is positioned in front of the supply device such that the first coupling arrangement is aligned with the second coupling arrangement in such a manner that they can be connected by a straight movement towards one another.

5. The method for operating a system according to claim 4, wherein after positioning, the floor cleaning machine moves exclusively in a straight movement in the opposite direction to the first direction of travel.

6. The method for operating a system according to claim 1, wherein the movement in the opposite direction to the first direction of travel is interrupted for a time interval.

7. The method for operating a system according to claim 6, wherein the movement in the opposite direction to the first direction of travel after the interruption is carried out at a reduced speed compared to the speed before the interruption.

8. The method for operating a system according to claim 1, wherein the floor cleaning machine has a detection unit for detecting objects in the region of the first coupling arrangement,
wherein, during the movement of the floor cleaning machine in the opposite direction to the first direction of travel, the detection unit is used to check whether there are objects present between the floor cleaning machine and the supply device, and
wherein, if the detection unit detects an object in the vicinity of the supply device, the movement of the floor cleaning machine in the opposite direction to the first direction of travel is stopped.

9. The method for operating a system according to claim 1, wherein the first coupling arrangement has a waste water valve that is connected to the waste water tank,
wherein the waste water valve has a closed position and an open position and can be transferred from the closed position to the open position by actuating an actuating element,
wherein, when the waste water valve is in the open position and the first coupling arrangement is connected to the second coupling arrangement, waste water can be conveyed from the waste water tank to the waste water outlet,
wherein the supply device has an actuator that can engage with the actuating element when the first and the second coupling arrangement are connected,
wherein, in order to convey waste water from the waste water tank to the waste water outlet, the actuator engages with the actuating element and transfers the waste water valve to the open position.

10. The method for operating a system according to claim 9, wherein after conveying the waste water from the waste water tank to the waste water outlet, fresh water is supplied from the supply device, to the waste water valve while the waste water valve is in the open position in order to flush the waste water valve.

11. The method for operating a system according to claim 10, wherein the level in the waste water tank is detected, and
wherein fresh water is supplied from the supply device to the waste water valve in order to flush the waste water valve when the level in the waste water tank has fallen below a minimum level.

12. The method for operating a system according to claim 1, wherein, while conveying fresh water from the fresh water inlet into the fresh water tank in the supply device, the amount of fresh water conveyed is detected,
wherein, while conveying fresh water from the fresh water inlet into the fresh water tank, the level of the fresh water in the fresh water tank of the floor cleaning machine is detected, and
wherein the conveying of fresh water is stopped when the increase in the level in the fresh water tank does not correspond to the amount of fresh water conveyed as detected.

13. The method for operating a system according to claim 1, wherein, while conveying fresh water from the fresh water inlet into the fresh water tank in the supply device, the level of fresh water in the fresh water tank of the floor cleaning machine is detected, and
wherein the conveying of fresh water is stopped when the level in the fresh water tank has reached a maximum level.

14. A system comprising a floor cleaning machine and a supply device having a chassis with at least one wheel that is driven by a chassis drive, wherein the chassis is designed in such a way that the floor cleaning machine can be moved over a floor surface, wherein the floor cleaning machine has at least one cleaning device that is designed to engage with the floor surface, wherein the floor cleaning machine has a fresh water tank for holding fresh water, a waste water tank for holding waste water and/or a rechargeable battery for supplying power to the floor cleaning machine and a first coupling arrangement, wherein the fresh water tank, the waste water tank and/or the battery are connected to the first coupling arrangement; wherein the supply device can be moved by means of a drive unit connected to it on the floor surface in or in the opposite direction to a straight first direction of travel between a first and a second position, wherein the supply device is moved from the first to the second position by a movement in the first direction of travel, wherein the supply device has a second coupling arrangement that can be connected to the first coupling arrangement, and wherein the first direction of travel points in the direction in which the second coupling arrangement must be moved in order to be connected to the first coupling arrangement, wherein the second coupling arrangement is connected to a fresh water inlet, a waste water outlet and/or to a power supply, wherein the supply device and the floor cleaning machine are designed in such a way that, when the first and the second coupling arrangement are connected to one another, fresh water can be conveyed from the fresh water inlet into the fresh water tank and/or waste water can be conveyed from the waste water tank to the waste water outlet and/or the battery is connected to the power supply, wherein the system is configured to: actuate the supply device so that the supply device assumes the second position, move the floor cleaning machine in the opposite direction to the first direction of travel by means of the chassis drive, so that the floor cleaning machine moves towards the supply device in such a manner that during the movement the first coupling arrangement points towards the second coupling arrangement, couple the floor cleaning machine and the supply device by connecting the first coupling arrangement to the second coupling arrangement, convey fresh water from the fresh water inlet into the fresh water tank and/or conveying waste water from the waste water tank to the waste water outlet and/or charging the battery with the power supply, and release the connection between the first and the second coupling arrangement by moving the supply device in the opposite direction to the first direction of travel from the second position to the first position.
